(19) United States
(12) Patent Application Publication
(10) Pub. No.: US 2021/0065738 A1
(43) Pub. Date: Mar. 4, 2021

(54) MAGNETIC DISK DEVICE AND READ RETRY PROCESSING METHOD

(71) Applicants: Kabushiki Kaisha Toshiba, Tokyo (JP); Toshiba Electronic Devices & Storage Corporation, Tokyo (JP)

(72) Inventor: Manabu Akamatsu, Kawasaki (JP)

(21) Appl. No.: 16/808,570

(22) Filed: Mar. 4, 2020

(30) Foreign Application Priority Data
Sep. 4, 2019 (JP) 2019-161315

(51) Int. Cl. G11B 5/012; G11B 5/02

(52) U.S. Cl. CPC G11B 5/012; G11B 2005/0008; G11B 5/02

(57) ABSTRACT

According to one embodiment, a magnetic disk device including a first disk, a second disk, a first head operable to write data to the first disk and read data from the first disk, a second head operable to write data to the second disk and read data from the second disk, a first actuator including the first head, a second actuator including the second head, a first controller operable to control the first head and the first actuator, and a second controller operable to control the second head and the second actuator, wherein the first controller transfers first data in which a read error occurs to the second controller, and the second controller applies a read retry process to the first data transferred from the first controller.

### CROSS-REFERENCE TO RELATED APPLICATIONS

This application is based upon and claims the benefit of priority from Japanese Patent Application No. 2019-161315, filed Sep. 4, 2019, the entire contents of which are incorporated herein by reference.

### FIELD

Embodiments described herein relate generally to a magnetic disk device and a read retry processing method.

### BACKGROUND

In recent years, the number of magnetic disks has been increased in connection with the increase in the recording capacity of magnetic disk devices. To respond to the increase in the number of magnetic disks, a split actuator magnetic disk device, which comprises a plurality of actuators, for example, two actuators, has been suggested. The split actuator magnetic disk device comprises a plurality of controllers for independently controlling the respective actuators.

### BRIEF DESCRIPTION OF THE DRAWINGS

FIG. 1 is a block diagram showing the configuration of a magnetic disk device according to a first embodiment.

FIG. 2 is a schematic diagram showing a configuration example of a read system according to the first embodiment.

FIG. 3 is a flowchart showing an example of a read retry processing method according to the first embodiment.

FIG. 4 is a flowchart showing an example of a read retry processing method according to modification example 1.

### DETAILED DESCRIPTION

In general, according to one embodiment, a magnetic disk device comprising: a first disk; a second disk; a first head operable to write data to the first disk and read data from the first disk; a second head operable to write data to the second disk and read data from the second disk; a first actuator comprising the first head; a second actuator comprising the second head; a first controller operable to control the first head and the first actuator; and a second controller operable to control the second head and the second actuator, wherein the first controller transfers first data in which a read error occurs to the second controller, and the second controller applies a read retry process to the first data transferred from the first controller.

Embodiments will be described hereinafter with reference to the accompanying drawings. The drawings are merely examples and do not limit the scope of the invention.

### First Embodiment

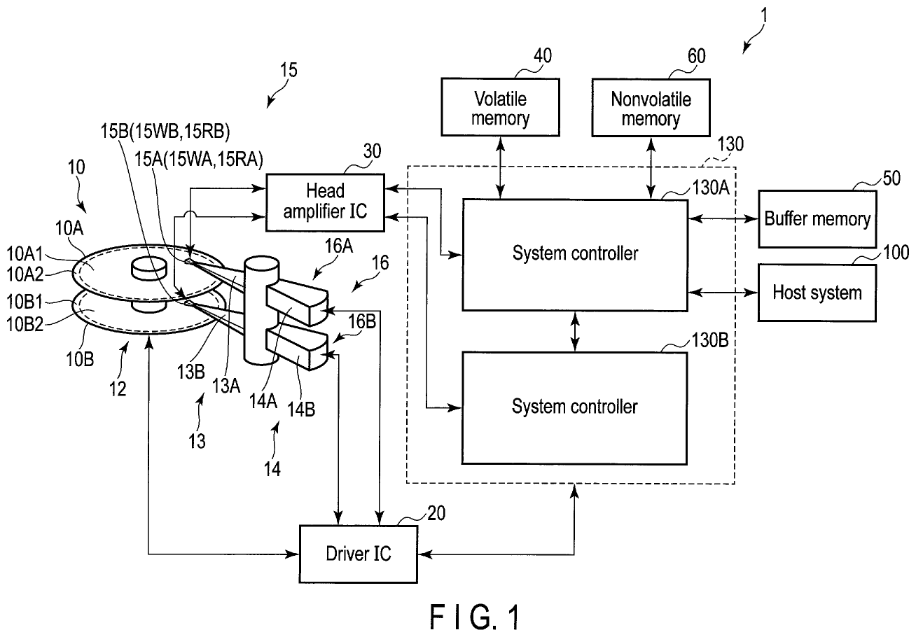

FIG. 1 is a block diagram showing the configuration of a magnetic disk device 1 according to a first embodiment.

The magnetic disk device 1 comprises a head disk assembly (HDA) as described later, a driver IC 20, a head amplifier integrated circuit (hereinafter, a head amplifier IC or a preamplifier) 30, a volatile memory 40, a buffer memory (buffer) 50, a nonvolatile memory 60 and a system controller 130 which is a single-chip integrated circuit. The magnetic disk device 1 is connected to a host system (hereinafter, simply referred to as a host) 100. The magnetic disk device 1 is a split actuator magnetic disk device configured to independently drive each of a plurality of actuators 16, for example, two actuators 16, as described later. The magnetic disk device 1 may comprise more than two actuators 16.

The HDA comprises a magnetic disk (hereinafter, referred to as a disk) 10, a spindle motor (hereinafter, referred to as an SPM) 12, an arm 13 on which a head 15 is mounted, and a voice coil motor (hereinafter, referred to as a VCM) 14. The disk 10 is attached to the spindle motor 12 and is rotated by the drive of the spindle motor 12. The disk 10 comprises, for example, disks 10A and 10B. The disk 10 may comprise three or more disks. Each of disks 10A and 10B may comprise two or more disks. The arm 13 comprises, for example, arms 13A and 13B. The arm 13 may comprise three or more arms. Each of arms 13A and 13B may comprise two or more arms. The VCM 14 comprise, for example, VCMs 14A and 14B. The VCM 14 may comprise three or more VCMs. The head 15 comprise, for example, heads 15A and 15B. The head 15 may comprise three or more heads. Each of heads 15A and 15B may comprise two or more heads. For example, head 15A is mounted on arm 13A. For example, head 15B is mounted on arm 13B.

The actuator 16 comprises actuators 16A and 16B. The actuator 16 may comprise three or more actuators. Actuators 16A and 16B are attached to a common pivot shaft, and are allowed to be rotated independently from each other about the pivot shaft. Actuator 16A comprises arm 13A and VCM 14A. Actuator 16A may include head 15A, the driver IC 20 and the head amplifier IC 30. Actuator 16A controls head 15A mounted on arm 13A by the drive of VCM 14A such that head 15A moves to a particular position of disk 10A. Actuator 16B comprises arm 13B and VCM 14B. Actuator 16B may include head 15B, the driver IC 20 and the head amplifier IC 30. Actuator 16B controls head 15B mounted on arm 13B by the drive of VCM 14B such that head 15B moves to a particular position of disk 10B.

In the disk 10, a user data area available to a user and a system area to which information necessary for system management is written are allocated to an area to which the data of the disk 10 can be written. For example, a user data area 10A1 and a system area 10A2 are allocated to disk 10A. A user data area 10B1 and a system area 10B2 are allocated to disk 10B. Hereinafter, a direction orthogonal to the radial direction of the disk 10 is referred to as a circumferential direction.

The head 15 comprises a slider as a main body, a write head and a read head. The write head and the read head are mounted on the slider. The write head writes data to the disk 10. The read head reads the data written to the disk 10. For example, head 15A comprises a write head 15WA which writes data to disk 10A, and a read head 15RA which reads the data written to disk 10A. For example, head 15B comprises a write head 15WB which writes data to disk 10B, and a read head 15RB which reads the data written to disk 10B.

The driver IC 20 controls the drive of the SPM 12 and the VCM 14 in accordance with the control of the system controller 130. In other words, the driver IC 20 controls the drive of the SPM 12 and the actuator 16 (actuators 16A and 16B) in accordance with the control of the system controller 130. A plurality of driver ICs 20 may be provided based on the number of actuators 16. For example, the driver IC 20 may comprise a driver IC which controls the drive of actuator 16A in accordance with the control of the system controller 130 (specifically, a system controller 130A as described later), and a driver IC which controls the drive of actuator 16B in accordance with the control of the system controller 130 (specifically, a system controller 130B as described later).

The head amplifier IC (preamplifier) 30 comprises a read amplifier and a write driver. The read amplifier amplifies a read signal read from the disk 10 (disks 10A and 10B) and outputs it to the system controller 130 (specifically, read/write (R/W) channels 131A and 131B as described later). The write driver outputs write current based on a signal output from the system controller 130 (specifically, R/W channels 131A and 131B as described later) to the head 15. A plurality of head amplifier ICs 30 may be provided based on the number of actuators 16. For example, the head amplifier IC 30 may comprise a head amplifier IC which applies signal processing to a read signal read from disk 10A by head 15A mounted on actuator 16A, and a head amplifier IC comprising a read amplifier which applies signal processing to a read signal read from disk 10B by head 15B mounted on actuator 16B.

The volatile memory 40 is a semiconductor memory in which the stored data is lost when power supply is stopped. For example, the data necessary for the process of each unit of the magnetic disk device 1 is stored in the volatile memory 40. The volatile memory 40 is, for example, a dynamic random access memory (DRAM) or a synchronous dynamic random access memory (SDRAM).

The buffer memory 50 is a semiconductor memory which temporarily records data which is transmitted and received between the magnetic disk device 1 and the host 100. The buffer memory 50 may be configured integrally with the volatile memory 40. The buffer memory 50 is, for example, a DRAM, a static random access memory (SRAM), an SDRAM, a ferroelectric random access memory (FeRAM) or a magnetoresistive random access memory (MRAM).

The nonvolatile memory 60 is a semiconductor memory in which the stored data is recorded even when power supply is stopped. The nonvolatile memory 60 is, for example, a NOR or NAND flash read only memory (flash ROM or FROM).

The system controller (controller) 130 is realized by using a large-scale integrated circuit (LSI) called a System-on-a-Chip (SoC), in which a plurality of elements are integrated into a single chip. The system controller 130 is electrically connected to the driver IC 20, the head amplifier IC 30, the volatile memory 40, the buffer memory 50, the nonvolatile memory 60 and the host system 100. The system controller 130 comprises, for example, system controllers 130A and 130B. For example, system controller 130A is electrically connected to the driver IC 20, the volatile memory 40, the buffer memory (buffer) 50, the nonvolatile memory 60 and system controller 130B. System controller 130A is connected to the host 100. For example, system controller 130B is electrically connected to the driver IC 20, the head amplifier IC 30 and system controller 130B. The system controller 130 may comprise three or more system controllers 130.

Hereinafter, in the disk 10 (disks 10A and 10B), the head 15 (heads 15A and 15B), the head amplifier IC 30 and the system controller 130 (system controllers 130A and 130B), the system for processing the data read from the disk 10 may be called a read system.

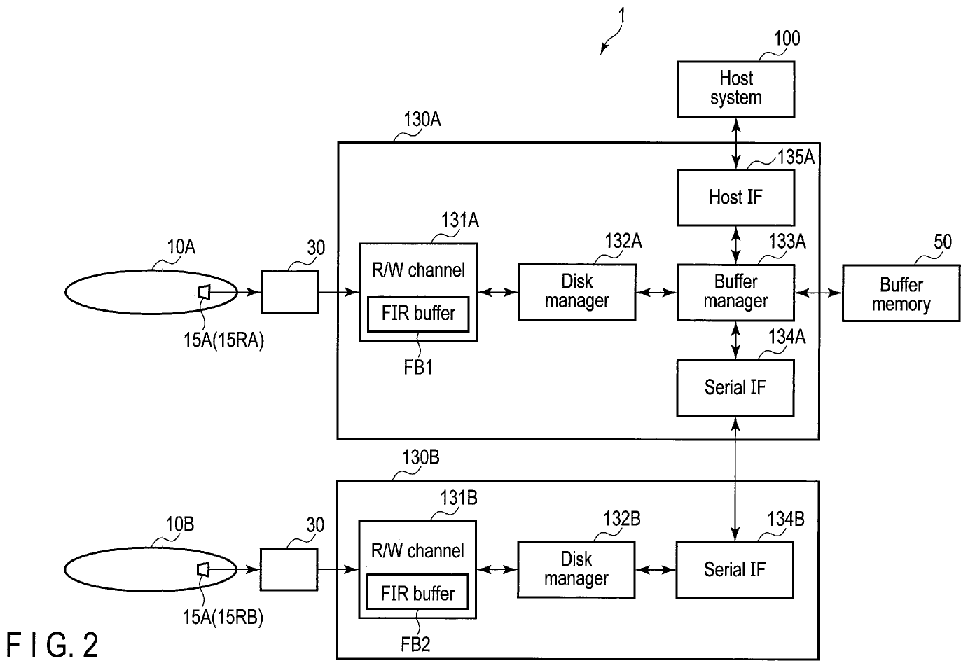

FIG. 2 is a schematic diagram showing a configuration example of a read system according to the present embodiment. FIG. 2 shows only the configuration necessary for explanation.

System controller 130A comprises, as a read system, a write/read (R/W) channel (hereinafter, which may be referred to as a read channel) 131A, a disk manager 132A, a buffer manager 133A, a serial interface (serial IF) 134A and a host interface (host IF) 135A.

R/W channel 131A comprises a memory, for example, a finite impulse response (FIR) buffer memory FB1. In the read system, R/W channel 131A temporarily records the data read from disk 10A (hereinafter, which may be referred to as read data) in a memory, for example, FIR buffer memory FB1. R/W channel 131A applies signal processing to read data in the read system. R/W channel 131A performs a process (hereinafter, which may be referred to as a read retry process) for applying various processes to, of the read data recorded in FIR buffer memory FB1, data which cannot be read and reading the data again. R/W channel 131A decodes read data (or may be referred to as a decoding process). R/W channel 131A is configured to perform various decoding processes in a read retry process. For example, in a read retry process, R/W channel 131A performs a decoding process for repeatedly decoding data which cannot be read until the data becomes readable while changing the conditions. For example, in a read retry process, when data in which sync mark cannot be read in a particular sector is read, R/W channel 131A performs resync for repeating a decoding process while displacing the position for starting reading the data. R/W channel 131A comprises a circuit or function for measuring the signal quality of read data. For example, in a read retry process, R/W channel 131A determines whether or not a read error occurs. R/W channel 131A determines whether or not system controller 130B (specifically, R/W channel 131B as described later) has a capacity (or processing capacity) for a read try process, for example, whether or not R/W channel 131B is in an idle state. R/W channel 131A is configured to transfer and copy (replicate) the data recorded in a particular memory of system controller 130A, for example, in FIR buffer memory FB1, to system controller 130B (specifically, an FIR buffer memory FB2 of R/W channel 131B as described later), etc., via each unit such as disk manager 132A, buffer manager 133A, the buffer memory 50, serial IF 134A and each unit of system controller 130B. For example, when R/W channel 131A determines that system controller 130B (specifically, R/W channel 131B as described later) has a capacity (or processing capacity) for a read retry process, for example, determines that R/W channel 131B is in an idle state, R/W channel 131A copies the data recorded in a particular memory of system controller 130A, for example, in FIR buffer memory FB1, to system controller 13B (specifically, to FIR buffer memory FB2 of R/W channel 131B as described later). R/W channel 131A is also configured to receive, in a memory, for example, in FIR buffer memory FB1, the data retained by a recording medium, for example, by the buffer memory 50 and FIR buffer memory FB2 of R/W channel 131B.

Disk manager 132A controls data transfer with respect to the disk 10, for example, disk 10A. For example, disk manager 132A controls the transfer of the data (read data) read from disk 10A via head 15A (read head 15RA), the head amplifier IC 30, R/W channel 131A, buffer manager 133A, serial IF 134A, host IF 135A, each unit of system controller 130B, etc., in the read system.

Buffer manager 133A controls data transfer with respect to the buffer memory 50. For example, buffer manager 133A controls data transfer between R\W channel 131A, disk manager 132A, serial IF 134A, host IF 135A, system controller 130B, etc., and the buffer memory 50.

Serial IF 134A controls data transfer. For example, serial IF 134A is connected to system controller 130B (specifically, a serial IF 134B as described later) and controls data transfer with respect to system controller 130B.

Host IF 135A is connected to the host 100 and controls data transfer with respect to the host 100. For example, host IF 135A is connected to the host 100 and controls data transfer between the host 100 and system controllers 130A and 130B.

System controller 130B comprises, as a read system, an R/W channel (read channel) 131B, a disk manager 132B and a serial IF 134B.

R/W channel 131B comprises a memory, for example, FIR buffer memory FB2. In the read system, R/W channel 131B temporarily records the data read from disk 10B (read data) in a memory, for example, in FIR buffer memory FB2. R/W channel 131B applies signal processing to read data in the read system. R/W channel 131B applies a read retry process to the read data recorded in FIR buffer memory FB2. R/W channel 131B decodes read data. R/W channel 131B is configured to perform various decoding processes in a read retry process. For example, in a read retry process, R/W channel 131B performs a decoding process for repeatedly decoding data which cannot be read until the data becomes readable while changing the conditions. For example, R/W channel 131B performs resync. R/W channel 131B comprises a circuit or function for measuring the signal quality of read data. For example, in a read retry process, R/W channel 131B determines whether or not a read error occurs. R/W channel 131B determines whether or not system controller 130A (specifically, R/W channel 131A) has a capacity for a read retry process, for example, whether or not R/W channel 131A is in an idle state. R/W channel 131B is configured to transfer and copy the data recorded in a particular memory of system controller 130B, for example, in FIR buffer memory FB2, to FIR buffer memory FB1 of R/W channel 131A, etc., via each unit such as disk manager 132B, serial IF 134B, each unit of system controller 130A, the buffer memory 50, etc. For example, when R/W channel 131B determines that system controller 130A (specifically, R/W channel 131A) has a capacity for a read retry process, for example, determines that R/W channel 131A is in an idle state, R/W channel 1315 copies the data recorded in a particular memory of system controller 130B, for example, in FIR buffer memory FB2, to system controller 130A (specifically, to FIR buffer memory FB1 of R/W channel 131A). R/W channel 131B is also configured to receive, in a memory, for example, in FIR buffer memory FB2, the data retained by a recording medium, for example, by the buffer memory 50 and FIR buffer memory FB1 of R/W channel 131A.

Disk manager 132B controls data transfer with respect to the disk 10, for example, disk 10B. For example, disk manager 132B controls the transfer of the data (read data) read from disk 10B via head 15B (read head 15RB), the head amplifier IC 30, R/W channel 131B, serial IF 134B, each unit of system controller 130A, etc., in the read system.

Serial IF 134B controls data transfer. For example, serial IF 134B is connected to serial IF 134A of system controller 130A and controls data transfer with respect to system controller 130A.

For example, R/W channel 131A reads data written to a particular sector of disk 10A, records the read data in FIR buffer memory FB1, and decodes the read data recorded in FIR buffer memory FB1. R/W channel 131A determines whether or not the decoded read data (hereinafter, which may be referred to as decoded data) can be read. In other words, R/W channel 131A determines whether or not a read error occurs in decoded data. When R/W channel 131A determines that a read error occurs in decoded data, R/W channel 131A determines whether or not system controller 130B, for example, R/W channel 131B, is in an idle state. When R/W channel 131A determines that system controller 130B, for example, R/W channel 131B, is in an idle state, R/W channel 131A copies read data corresponding to decoded data recoded in FIR buffer memory FB1 and determined as data in which a read error occurs (hereinafter, which may be referred to as retry target data) to FIR buffer memory FB2 of R/W channel 131B via the buffer memory 50. After copying the retry target data of FIR buffer memory FB1 to FIR buffer memory FB2, R/W channel 131A performs a read retry process for repeating a process for reading again a particular sector of disk 10A to which data corresponding to the retry target data is written, recording the read data (retry target data) in FIR buffer memory FB1, decoding the retry target data recorded in FIR buffer memory FB1, and determining whether or not a read error occurs in the decoded retry target data (hereinafter, which may be referred to as target decoded data). When R/W channel 131A determines that a read error does not occur in the target decoded data, R/W channel 131A stops the read retry process in R/W channel 131B and transfers the target decoded data determined as data in which a read error does not occur to, for example, the host 100, via the buffer memory 50. In other words, when R/W channel 131A determines that the target decoded data can be read, R/W channel 131A stops the read retry process in R/W channel 131B, and transfers the target decoded data determined as data which can be read to, for example, the host 100, via the buffer memory 50.

In the case of an idle state, R/W channel 131B performs a read retry process for repeating a process for decoding the retry target data copied from FIR buffer memory FB1 to FIR buffer memory FB2 into target decoded data, and determining whether or not a read error occurs in the target decoded data. When R/W channel 131B determines that a read error does not occur in the target decoded data, R/W channel 131B stops the read retry process in R/W channel 131A and transfers the target decoded data determined as data in which a read error does not occur to, for example, the host 100, via the buffer memory 50. In other words, when R/W channel 131B determines that the target decoded data can be read, R/W channel 131B stops the read retry process in R/W channel 131A, and transfers the target decoded data determined as data which can be read to, for example, the host 100, via the buffer memory 50.

For example, R/W channel 131B reads the data written to a particular sector of disk 10B, records the read data in FIR buffer memory FB2, and decodes the read data recorded in FIR buffer memory FB2. R/W channel 131B determines whether or not the decoded data can be read. In other words, R/W channel 131B determines whether or not a read error occurs in the decoded data. When R/W channel 131B determines that a read error occurs in the decoded data, R/W channel 131B determines whether or not system controller 130A, for example, R/W channel 131A, is in an idle state. When R/W channel 131B determines that, for example, R/W channel 131A is in an idle state, R/W channel 131B copies the retry target data recorded in FIR buffer memory FB2 to FIR buffer memory FB1 of R/W channel 131A via the buffer memory 50. After copying the retry target data of FIR buffer memory FB2 to FIR buffer memory FB1, R/W channel 131B performs a read retry process for repeating a process for reading again a particular sector of disk 10B to which data corresponding to the retry target data is written, recording the read data (retry target data) in FIR buffer memory FB2, decoding the retry target data recorded in FIR buffer memory FB2, and determining whether or not a read error occurs in the target decoded data. When R/W channel 131B determines that a read error does not occur in the target decoded data, R/W channel 131B stops the read retry process in R/W channel 131A and transfers the target decoded data determined as data in which a read error does not occur to, for example, the host 100, via the buffer memory 50.

In the case of an idle state, R/W channel 131A performs a read retry process for repeating a process for decoding the retry target data copied from FIR buffer memory FB2 to FIR buffer memory FB1 into target decoded data, and determining whether or not a read error occurs in the target decoded data. When R/W channel 131A determines that a read error does not occur in the target decoded data, R/W channel 131A stops the read retry process in R/W channel 131B and transfers the target decoded data determined as data in which a read error does not occur to, for example, the host 100, via the buffer memory 50.

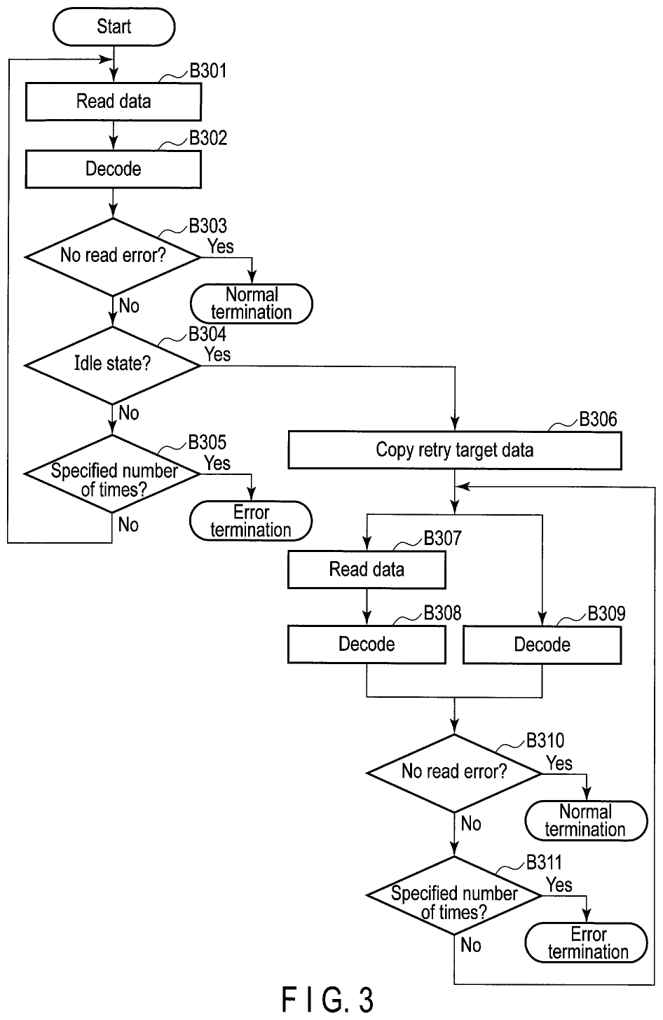

FIG. 3 is a flowchart showing an example of a read retry processing method according to the present embodiment.

The system controller 130 reads the data of the disk 10 (B301). For example, system controller 130A reads the data of disk 10A by head 15A, or system controller 130B reads the data of disk 10B by head 15B. The system controller 130 decodes the data read from the disk 10 into decoded data (B302), and determines whether or not a read error occurs in the decoded data (B303). For example, system controller 130A decodes the data read from disk 10A into decoded data, and determines whether or not a read error occurs in the decoded data. System controller 130B decodes the data read from disk 10B into decoded data, and determines whether or not a read error occurs in the decoded data. When the system controller 130 determines that a read error does not occur in the decoded data (YES in B303), the system controller 130 normally terminates the read process. When the system controller 130 determines that a read error occurs in the decoded data (NO in B303), the system controller 130 determines whether or not the system controller other than the system controller which read the data is in an idle state (B304). For example, when the system controller 130 determines that a read error occurs in the decoded data, system controller 130A determines whether or not system controller 130B, for example, R/W channel 131B, is in an idle state. For example, when the system controller 130 determines that a read error occurs in the decoded data, system controller 130B determines whether or not system controller 130A, for example, R/W channel 131A, is in an idle state. When the system controller 130 determines that the system controller other than the system controller which read the data is not in an idle state (NO in B304), the system controller 130 determines whether or not a read retry process is performed a specified number of times (B305). When the system controller 130 determines that a read retry process is performed a specified number of times (YES in B305), the system controller 130 terminates the read process as an error. When the system controller 130 determines that a read retry process is not performed a specified number of times (NO in B305), the system controller 130 proceeds to the process of B301.

When the system controller 130 determines that the system controller other than the system controller which read the data is in an idle state (YES in B304), the system controller 130 copies the retry target data recoded in the memory of the system controller which read the data to the memory of the system controller in an idle state. For example, when the system controller 130 determines that system controller 130B, for example, R/W channel 131B, is in an idle state, system controller 130A copies the retry target data recorded in FIR buffer memory FB1 of R/W channel 131A to FIR buffer memory FB2 of R/W channel 131B of system controller 130B. For example, when the system controller 130 determines that system controller 130A, for example, R/W channel 131A, is in an idle state, system controller 130B copies the retry target data recorded in FIR buffer memory FB2 of R/W channel 131B to FIR buffer memory FB1 of R/W channel 131A of system controller 130A.

The system controller 130 again reads the sector of the disk 10 to which data corresponding to the retry target data is written in the system controller which read the data (B307), decodes the read data (retry target data) into decoded data (target decoded data) (B308), and proceeds to the process of B310. For example, system controller 130A again reads the sector of disk 10A to which data corresponding to the retry target data is written, and decodes the read data (retry target data) into decoded data (target decoded data). For example, system controller 130E again reads the sector of disk 10B to which data corresponding to the retry target data is written, and decodes the read read data (retry target data) into target decoded data (target decoded data).

The system controller 130 decodes the retry target data copied to the memory by the system controller other than the system controller which read the data into target decoded data (B309). For example, system controller 130B decodes the retry target data copied from FIR buffer memory FB1 to FIR buffer memory FB2 by system controller 130A, for example, by R/W channel 131A, into target decoded data. For example, system controller 130A decodes the retry target data copied from FIR buffer memory FB2 to FIR buffer memory FB1 by system controller 130A, for example, by R/W channel 131B, into target decoded data.

The system controller 130 determines whether or not a read error occurs in the target decoded data (B310). For example, system controller 130A determines whether or not a read error occurs in the target decoded data. For example, system controller 130B determines whether or not a read error occurs in the target decoded data. When the system controller 130 determines that a read error does not occur in the target decoded data (YES in B310), the system controller 130 normally terminates the read process. For example, when the system controller 130 determines that a read error does not occur in the target decoded data, system controller 130B stops the read retry process of system controller 130A, for example, R/W channel 131A, and normally terminates the read process. For example, when the system controller 130 determines that a read error does not occur in the target decoded data, system controller 130A stops the read retry process of system controller 130B, for example, R/W channel 131B, and normally terminates the read process.

When the system controller 130 determines that a read error occurs in the target decoded data (NO in B310), the system controller 130 determines whether or not a read retry process is performed a specified number of times (B311). When the system controller 130 determines that a read retry process is performed a specified number of times (YES in B311), the system controller 130 terminates the read process as an error. When the system controller 130 determines that a read retry process is not performed a specified number of times (NO in B311), the system controller 130 proceeds to the processes of B307 and B309.

According to the embodiment, the magnetic disk device 1 comprises a plurality of actuators 16, for example, actuators 16A and 16B, which are independently driven, and a plurality of system controllers 130, for example, system controllers 130A and 130B, which correspond to the actuators, respectively. System controller 130A comprises R/W channel 131A comprising FIR buffer memory FB1. System controller 130B comprises R/W channel 131B comprising FIR buffer memory FB2. System controller 130A reads data from disk 10A via head 15A mounted on actuator 16A and the head amplifier IC 30. System controller 130B reads data from disk 10B via head 15B mounted on actuator 16B and the head amplifier IC 30. System controller 130A records the data read from disk 10A in FIR buffer memory FB1, decodes the data recoded in FIR buffer memory FB1 into decoded data, and determines whether or not a read error occurs in the decoded data. When system controller 130A determines that a read error occurs in the decoded data, system controller 130A determines whether or not system controller 130B, for example, R/W channel 131B, is in an idle state. When system controller 130A determines that R/W channel 131B is in an idle state, system controller 130A copies the retry target data recorded in FIR buffer memory FB1 of R/W channel 131A to FIR buffer memory FB2 of R/W channel 131B. System controller 130A again reads the sector to which data corresponding to the retry target data is written, and applies a read retry process to the read retry target data. For example, system controller 130B applies a read retry process to the retry target data copied from FIR buffer memory FB1 to FIR buffer memory FB2 by system controller 130A, for example, by R/W channel 131A. When the system controller 130 determines that a read error does not occur in the target decoded data in the read retry process, system controller 130A stops the read retry process of R/W channel 131B, and transfers the target decoded data determined as data in which a read error does not occur to, for example, the host 100, via the buffer memory 50. When the system controller 130 determines that a read error does not occur in the target decoded data in the read retry process, system controller 130B stops the read retry process of R/W channel 131A, and transfers the target decoded data determined as data in which a read error does not occur to, for example, the host 100, via the buffer memory 50. The magnetic disk device 1 is configured to perform a read retry process by a plurality of system controllers, for example, a plurality of R/W channels, which correspond to a plurality of actuators, respectively. Thus, the magnetic disk device 1 is capable of effectively performing read retry. Therefore, the magnetic disk device 1 is capable of improving the performance of a read process.

Now, this specification explains the magnetic disk device according to a modification example of the first embodiment. In the modification example, the same portions as the first embodiment are denoted by like reference numbers, detailed description thereof being omitted.

### Modification Example 1

The magnetic disk device 1 of modification example 1 is different from the magnetic disk device 1 of the first embodiment described above in terms of a read retry processing method.

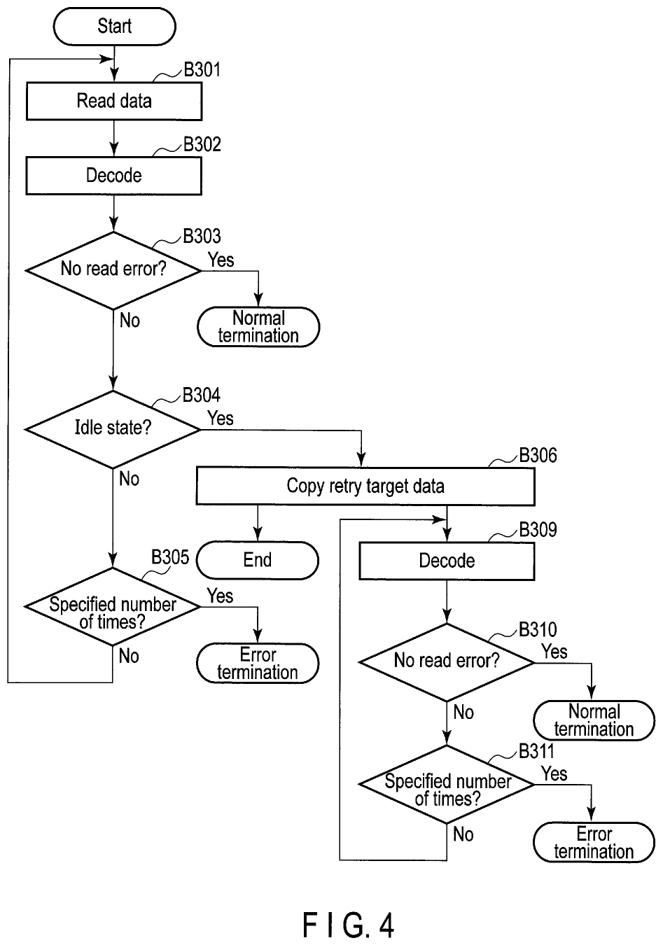

FIG. 4 is a flowchart showing an example of a read retry processing method according to modification example 1.

The system controller 130 reads the data of the disk 10 (B301), decodes the data read from the disk 10 into decoded data (6302), and determines whether or not a read error occurs in the decoded data (B303). When the system controller 130 determines that a read error does not occur in the decoded data (YES in B303), the system controller 130 normally terminates the read process. When the system controller 130 determines that a read error occurs in the decoded data (NO in B303), the system controller 130 determines whether or not the system controller other than the system controller which read the data is in an idle state (B304).

When the system controller 130 determines that the system controller other than the system controller which read the data is in an idle state (YES in B304), the system controller 130 copies the retry target data recoded in the memory of the system controller which read the data to the memory of the system controller in an idle state (B306), and terminates the read retry process of the system controller which read the data. For example, when the system controller 130 determines that system controller 130B is in an idle state, system controller 130A copies the retry target data recorded in FIR buffer memory FB1 of R/W channel 131A to FIR buffer memory FB2 of R/W channel 131B of system controller 130B, and reads a particular sector of disk 10A to be read after the sector to which data corresponding to the retry target data is written by a command, etc. For example, when the system controller 130 determines that system controller 130A is in an idle state, system controller 130B copies the retry target data recorded in FIR buffer memory FB2 of R/W channel 131B to FIR buffer memory FB1 of R/W channel 131A of system controller 130A, and reads a particular sector of disk 10B to be read after the sector to which data corresponding to the retry target data is written by a command, etc.

The system controller 130 decodes the retry target data copied to the memory by the system controller other than the system controller which read the data into target decoded data (B309), and determines whether or not a read error occurs in the target decoded data (B310). When the system controller 130 determines that a read error does not occur in the target decoded data (YES in B310), the system controller 130 normally terminates the read process. When the system controller 130 determines that a read error occurs in the target decoded data (NO in B310), the system controller 130 determines whether or not a read retry process is performed a specified number of times (B311). When the system controller 130 determines that a read retry process is performed a specified number of times (YES in B311), the system controller 130 terminates the read process as an error. When the system controller 130 determines that a read retry process is not performed a specified number of times (NO in B311), the system controller 130 proceeds to the process of B309.

According to modification example 1, when the magnetic disk device 1 determines that a read error occurs in decoded data, the magnetic disk device 1 determines whether or not the system controller, for example, system controller 130B, other than the system controller which read the data, for example, other than system controller 130A, is in an idle state. When the magnetic disk device 1 determines that system controller 130B is in an idle state, the magnetic disk device 1 copies the retry target data recorded in FIR buffer memory FB1 of R/W channel 131A to FIR buffer memory FB2 of R/W channel 131B of system controller 130B, and reads a particular sector of disk 10A to be read after the sector to which data corresponding to the retry target data is written by a command, etc. For example, system controller 130B applies a read retry process to the retry target data copied from FIR buffer memory FB1 to FIR buffer memory FB2 by system controller 130A, for example, by R/W channel 131A. Therefore, the magnetic disk device 1 is capable of improving the performance of a read process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a first disk;
a second disk;
a first head operable to write data to the first disk and read data from the first disk;
a second head operable to write data to the second disk and read data from the second disk;
a first actuator comprising the first head;
a second actuator comprising the second head;
a first controller operable to control the first head and the first actuator; and
a second controller operable to control the second head and the second actuator, wherein
the first controller transfers first data in which a read error occurs to the second controller, and
the second controller applies a read retry process to the first data transferred from the first controller.

2. The magnetic disk device of claim 1, wherein
the first controller comprises a first read channel comprising a first memory,
the second controller comprises a second read channel comprising a second memory, and
when the second read channel is in an idle state, the first read channel copies the first data from the first memory to the second memory.

3. The magnetic disk device of claim 2, further comprising a buffer memory connected to the first controller, wherein
the first read channel copies the first data from the first memory to the second memory via the buffer memory.

4. The magnetic disk device of claim 2, wherein
the second read channel decodes the first data copied to the second memory into second data, and terminates the read retry process when a read error does not occur in the second data.

5. The magnetic disk device of claim 2, wherein
the second read channel decodes the first data copied to the second memory into second data, and decodes the first data into third data when a read error occurs in the second data.

6. The magnetic disk device of claim 2, wherein
the first read channel applies the read retry process to the first data recoded in the first memory after the first data is copied from the first memory to the second memory.

7. The magnetic disk device of claim 6, wherein
the first read channel decodes the first data recorded in the first memory into fourth data, and terminates the read retry process when a read error does not occur in the fourth data.

8. The magnetic disk device of claim 2, wherein
the first controller reads a second sector different from a first sector of a disk to which the first data is written after the first data is copied from the first memory to the second memory.

9. The magnetic disk device of claim 1, wherein
the first controller comprises a first read channel comprising a first memory,
the second controller comprises a second read channel comprising a second memory,
the first read channel copies the first data from the first memory to the second memory when the second read channel has a capacity for performing the read retry process, and
the second read channel applies the read retry process to the first data copied to the second memory.

10. The magnetic disk device of claim 9, wherein
the second read channel decodes the first data copied to the second memory into second data, and terminates the read retry process when a read error does not occur in the second data.

11. A read retry processing method applied to a magnetic disk device comprising:
a first disk;
a second disk;
a first head operable to write data to the first disk and read data from the first disk;
a second head operable to write data to the second disk and read data from the second disk;
a first actuator comprising the first head;
a second actuator comprising the second head;
a first controller operable to control the first head and the first actuator; and
a second controller operable to control the second head and the second actuator,
the method comprising:
transferring first data in which a read error occurs from the first controller to the second controller; and
applying a read retry process to the first data transferred from the first controller in the second controller.

12. The read retry processing method of claim 11, wherein
the first controller comprises a first read channel comprising a first memory,
the second controller comprises a second read channel comprising a second memory, and
when the second read channel is in an idle state, the first data is copied from the first memory to the second memory.

13. The read retry processing method of claim 12, further comprising a buffer memory connected to the first controller, wherein
the first data is copied from the first memory to the second memory via the buffer memory.

14. The read retry processing method of claim 12, wherein
in the second read channel, the first data copied to the second memory is decoded into second data, and when a read error does not occur in the second data, the read retry process is terminated.

15. The read retry processing method of claim 12, wherein
in the second read channel, the first data copied to the second memory is decoded into second data, and in the second read channel, when a read error occurs in the second data, the first data is decoded into third data.

16. The read retry processing method of claim 12, wherein
in the first read channel, after the first data is copied from the first memory to the second memory, the read retry process is applied to the first data recorded in the first memory.

17. The read retry processing method of claim 16, wherein
in the first read channel, the first data recorded in the first memory is decoded into fourth data, and when a read error does not occur in the fourth data, the read retry process is terminated.

18. The read retry processing method of claim 12, wherein
after the first data is copied from the first memory to the second memory, a second sector different from a first sector of a disk to which the first data is written is read.

19. The read retry processing method of claim 11, wherein
the first controller comprises a first read channel comprising a first memory,
the second controller comprises a second read channel comprising a second memory,
the first data is copied from the first memory to the second memory when the second read channel has a capacity for performing the read retry process, and
the read retry process is applied to the first data copied to the second memory in the second read channel.

20. The read retry processing method of claim 19, wherein
in the second read channel, the first data copied to the second memory is decoded into second data, and when a read error does not occur in the second data, the read retry process is terminated.
